(19) United States
(12) Patent Application Publication
(10) Pub. No.: US 2005/0137801 A1
(43) Pub. Date: Jun. 23, 2005

(54) Vehicle sensing system for drive-through retail outlet

(76) Inventor: Trevor Kern, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/010,712

(22) Filed: Dec. 13, 2004

(30) Foreign Application Priority Data
Dec. 17, 2003 (CA) 2,451,906

(51) Int. Cl. G06F 7/00

(52) U.S. Cl. 701/301; 701/1

(57) ABSTRACT

A vehicle sensing system for a drive-through retail outlet. The vehicle sensing system includes a building housing a drive-through retail outlet. The building has exterior defining walls with at least one service window. A service lane is provided which is adapted to accommodate vehicular traffic. The service lane is positioned immediately adjacent to at least one of the exterior defining walls. At least one magnetic anomaly detector is positioned along the at least one of the exterior defining walls on the inside of the building. The magnetic anomaly detector is adapted to detect vehicles in the service lane approaching the at least one service window.

### FIELD OF THE INVENTION

The present invention relates to a vehicle sensing system for a drive-through retail outlet using magnetic anomaly detector technology and, a magnetic anomaly detector configured for use in accordance with the teachings of the method.

### BACKGROUND OF THE INVENTION

Drive-through restaurants have a vehicle service lane which passes beside one or more service windows. Vehicle sensing systems are used to alert service personnel as to the presence of vehicles in the service lane. Often the vehicle sensing systems are a small part of more elaborate service tracking systems, which time and record vehicle movements for the purpose of ensuring that minimum levels of service are maintained. Vehicle sensing systems currently in use with drive-through restaurants are sensing loops embedded in concrete beneath the vehicle service lane. These loops are very costly to install, and to trench wires from loop to the detector amplifier located in-restaurant. They also must be “reset” when no vehicle is present over the loop to operate properly. Problems have also been experienced in maintaining these embedded vehicle sensing systems. One problem relates to ground movement which tends to damage the sensing loops and sever connections to the sensing loops. Another problem is oil damage that may occur, where the loop is exposed due to erosion or the road falling into disrepair.

### SUMMARY OF THE INVENTION

What is required is a more practical vehicle sensing system for a drive-through retail outlet.

According to one aspect of the present invention there is provided a vehicle sensing system for a drive-through retail outlet. The vehicle sensing system includes a building housing a drive-through retail outlet. The building has exterior defining walls with at least one service window. A service lane is provided which is adapted to accommodate vehicular traffic. The service lane is positioned immediately adjacent to at least one of the exterior defining walls. At least one magnetic anomaly detector is positioned along the at least one of the exterior defining walls on the inside of the building. The magnetic anomaly detector is adapted to detect vehicles in the service lane approaching the at least one service window.

With the vehicle sensing system, as described above, the magnetic anomaly detectors are mounted inside of the building housing the drive-through retail outlet. Positioned inside of the building, they are protected from ground movement and are readily available for inspection and servicing. In addition, the system will be less costly to install, will not require major construction to install, and will not be as prone to damage as a result of ground movement.

Beneficial results may be obtained from the vehicle sensing equipment because it can be inexpensively installed or retrofitted.

Another problem which exists with prior art vehicle sensing systems, is that an unusual vehicle movement can create havoc with service tracking systems. For example, if a vehicle leaves the service window and then backs up to return to the service window. This frequently happens in a drive-through restaurant context, because something as minor as a straw or a napkin has been inadvertently omitted from the order. Even more beneficial results may, therefore, be obtained when the magnetic anomaly detector is uni-directional. The uni-directional detector will only sense vehicles moving in a forward direction along the service lane, while a single loop system is unable to determine direction.

According to another aspect of the present invention there is provided a magnetic anomaly detector, which includes a housing and a mounting for the housing adapted to secure the housing to a vertical wall. Detection electronics within the housing are oriented to detect the presence of vehicles passing adjacent to the wall on which the housing is mounted.

Although beneficial results may be obtained through the use of the magnetic anomaly detector, as described above, even more beneficial results may be obtained when the housing includes a computer processor with a complete timer system to form a self contained system adapted to record service data.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view with a vehicle sensing system for drive-through retail outlet constructed in accordance with the teachings of the present invention;

FIG. 2 is a front view of a detector used with the present invention; and

FIG. 3 is a side view of a detector used with the present invention.

### DETAILED DESCRIPTION OF THE PREFERRED EMBODIMENT

The preferred embodiment, a vehicle sensing system for a drive-through retail outlet generally identified by reference numeral 10, will now be described.

Structure and Relationship of Parts:

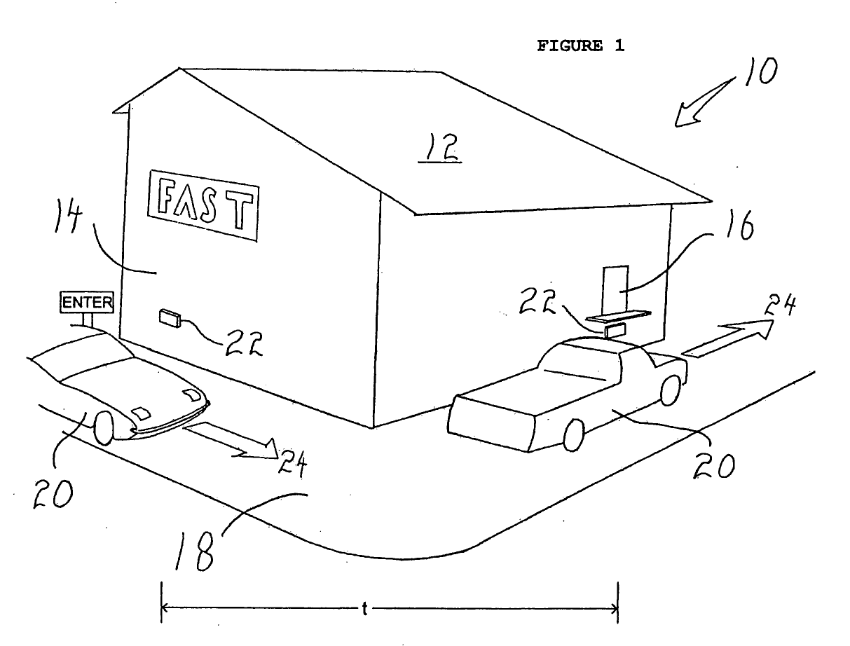

With reference to FIG. 1, vehicle sensing system 10 has a building housing a drive-through retail outlet 12 having exterior defining walls 14 with at least one service window 16. A service lane 18, adapted to accommodate vehicular traffic 20, is positioned immediately adjacent to at least one of exterior defining walls 14. At least one magnetic anomaly detector 22 is positioned inside building 12 along at least one of exterior defining walls 14. Magnetic anomaly detector 22 is adapted to detect vehicles in service lane 18 as they approach service window 16. In the illustrated embodiment, one service window 16 and one magnetic anomaly detector 22 are shown and service lane 18 is adjacent to two walls 14.

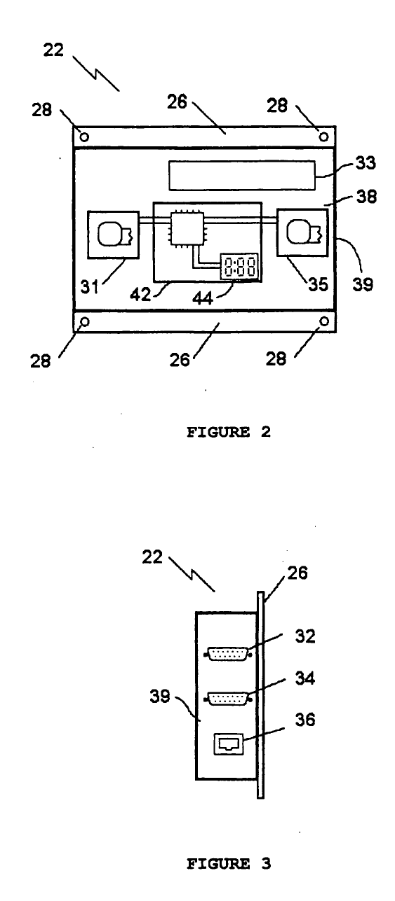

Referring to FIG. 2, a magnetic anomaly detector 22 is shown with housing 38. The detector 22 is secured to a vertical wall 14 using a mounting, such as holes 28 in bracket 26. Two detection electronics (sensors) 31 and 35 are positioned within housing 38 and are oriented to detect the presence of vehicles 20 passing adjacent to the wall on which the housing 38 is mounted. For example, when the housing 38 is mounted to an interior wall of a building, the detection electronics 31 are oriented to detect the presence of vehicles 20 passing adjacent to the wall outside of the building. Detection electronics 31 and 35 are horizontally spaced apart within housing 38. The direction of vehicular movement is determined by the order in which detection electronics 31 and 35 are triggered. If a vehicle passes by in a forward direction detection electronics 35 is triggered first. However, if a vehicle passes by in the reverse direction, detection electronics 31 is triggered first. It is preferred that the housing also include a computer processor 42 with a timing system 44 adapted to monitor service efficiency. The processor may include memory, a real time clock, and other useful components. Service data from the timing system and computer processor may be recorded over time to monitor trends in customer flow, improvements in service efficiency and other statistics. The magnetic anomaly detector 22 may also include other features such as a user panel 33.

In the illustrated embodiment, direction is determined by having two sensors spaced horizontally apart within the housing. With this sensor configuration, determination of direction can be made by which sensor senses the presence of a vehicle first. The controller is programmed to only recognise, when the sensors sense the presence of the vehicle in a desired direction. With this configuration of sensors the “Z” axis is used. It will be appreciated by persons skilled in the art that it may also be possible to detect direction through the use of a single sensor, if a combination of two sensing axes is used.

Referring to FIG. 3, a side view of the detector 22 is shown. There may be provided an interface 39 which is adapted to interface the computer processor with a printer through connection 34, a computer network through connection 36, or to a computer monitor or other display through connection 32.

Operation:

The use and operation of vehicle sensing system for drive-through retail outlet 10 will now be described with reference to FIG. 1. Service lane 18 is adapted so as to channel vehicular traffic 20 adjacent to exterior defining walls 14 and past service window 16. The use of vehicle sensing system 10 allows detector 22 to be installed inside building 12 and eliminates any apparatus that would be prone to damage if it was outside the building. As traffic 20 moves in a forward direction 24, detector 22 senses the movement and registers the information for use by the operators, such as the time t it takes a vehicle to reach the window after entering the service lane. A computer processor 42 processes information received by the detector 22. The information may then be sent to a monitor, a network, or a printer. In the illustrated embodiment, magnetic anomaly detector 22 is uni-directional, distinguishing between forward and backward movement of vehicular traffic 20.

Referring to FIG. 3, the detector 22 allows communication between the detector and the service providers through the connections 32, 34, and 36.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. A vehicle sensing system for a drive-through retail outlet, comprising in combination:
a building housing a drive-through retail outlet, the building having exterior defining walls with at least one service window;
a service lane adapted to accommodate vehicular traffic, the service lane being positioned immediately adjacent to at least one of the exterior defining walls;
at least one magnetic anomaly detector positioned along the at least one of the exterior defining walls on the inside of the building, the magnetic anomaly detector being adapted to detect vehicles in the service lane approaching the at least one service window.

2. The vehicle sensing system as defined in claim 1, wherein the magnetic anomaly detector is uni-directional, adapted to only sense vehicles moving in a forward direction along the service lane.

3. A magnetic anomaly detector, comprising:
a housing;
a mounting for the housing adapted to secure the housing to a vertical wall;
detection electronics within the housing oriented to detect the presence of vehicles passing adjacent to the wall on which the housing is mounted.

4. The magnetic anomaly detector as defined in claim 3, wherein, when the housing is mounted to an interior wall of a building, the detection electronics is oriented to detect the presence of vehicles passing adjacent to the wall outside of the building.

5. The magnetic anomaly detector as defined in claim 3, wherein the housing includes a computer processor with a timing system adapted to record service data.

6. The magnetic anomaly detector as defined in claim 3, wherein the detector electronics are configured to determine direction of vehicular movement.

7. The magnetic anomaly detector as defined in claim 3, wherein a computer processor is housed within the housing, an interface being provided on the housing which is adapted to interface the computer processor with a display.

8. The magnetic anomaly detector as defined in claim 3, wherein a computer processor is housed within the housing, an interface being provided on the housing which is adapted to interface the computer processor with a printer.

9. The magnetic anomaly detector as defined in claim 3, wherein a computer processor is housed within the housing, an interface being provided on the housing which is adapted to interface the computer processor with a computer network.
